(19) United States
(12) Patent Application Publication
(10) Pub. No.: US 2008/0229604 A1
(43) Pub. Date: Sep. 25, 2008

(54) Digital thickness gauge for both exterior dimension and tube or hollow wall thickness

(76) Inventor: Lin Wo, Suzhou New District (CN)

Correspondence Address: DONN K. HARMS;PATENT & TRADEMARK LAW CENTER, SUITE 100, 12702 VIA CORTINA, DEL MAR, CA, 92014, US

(21) Appl. No.: 12/077,652

(22) Filed: Mar. 19, 2008

Related U.S. Application Data
(60) Provisional application No. 60/919,107, filed on Mar. 19, 2007.

(51) Int. Cl. G01B 5/02

(52) U.S. Cl. 33/784

(57) ABSTRACT

A measuring instrument displaying measurements on a digital display for either exterior dimensional measurements of a component or wall thickness measurements of pipe or tubing. Exterior dimensions are determined through contact between the distal end of a first member and the distal end of the base. A second member engaged with the first member is translatable along a second axis traverse to the first axis to an extended position. Wall thickness of a tube or conduit may be measured by a contact with a distal end of the second member and the distal end of the first member. A globular shape to the distal end of the second member allows for accurate measurements in a contact with the interior of either a planar or curved tubing sidewall.

### FIELD OF THE INVENTION

This application claims priority from U.S. Provisional Patent Application Ser. No. 60/919,107 filed Mar. 19, 2007. The disclosed device relates to digital calipers and gauges. More particularly, it relates to a digital caliper that is adapted to measure both exterior dimensions of parts placed in it and the wall thickness of hollow parts such as tubing.

### BACKGROUND OF THE INVENTION

A thickness gauge or caliper is a device used to measure the distance between two symmetrically opposing sides. A caliper can be as simple as a compass with inward or outward-facing points. The tips of the caliper are adjusted to fit across the points to be measured, the caliper is then removed, and the distance is read by measuring between the tips with a measuring tool such as a ruler.

Thickness gauges and calipers are used in the metalworking field. The legs of inside calipers are curved outward at the extremities to facilitate measuring small apertures and openings, while the outside caliper legs have a large curve inward to increase their capacity for large work such as pipes, beans, and such. Measuring either inside or outside dimensions, calipers can be set to a ruler or to a standard part, the latter being the most accurate. The use of calipers is not confined to cylindrical work. Calipers are often employed also in checking rectangular holes, parallel faces and so on.

A further refinement to the vernier caliper is the dial caliper where a small gear rack drives a pointer on a circular dial. Typically, the pointer on an analog dial rotates once every inch, tenth of an inch, or 10 millimeters, allowing for a direct reading.

A refinement now popular is the replacement of the analog dial with an electronic digital display. This version of the caliper allows reading the value being measured directly from a single display. Many digital calipers can be switched between metric and imperial units, making use of different international numerical methods an easy switch for the user. Particularly convenient, most such digital devices provide for zeroing the display at any point along the slide. Once so zeroed, the subsequent measurement will show some sort of differential measurement.

For very accurate measurements of exterior diameter or thickness, digital calipers or thickness gauges generally have a translating member that seats against a surface on the reverse curve of the distal end of a fixed leg. Whether digital or analog, exterior calipers are generally not adapted to measure the wall thickness of tubes because legs and measuring surfaces will not fit well in such confines. Generally in order to measure the inside of a tube or conduit for wall thickness, an interior caliper or gauge must be employed.

With respect to the above, before explaining at least one preferred embodiment of the invention in detail, it is to be understood that the invention is not limited in its application to the details of construction and to the arrangement of the components or steps set forth in the following description or illustrated in the drawings. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other caliper and gauge measuring devices and methods and systems for carrying out the several purposes of the present disclosed device. It is important, therefore, that the objects and claims be regarded as including such equivalent construction and methodology insofar as they do not depart from the spirit and scope of the present invention.

### SUMMARY OF THE INVENTION

The disclosed device is employed in a similar fashion to digital and mechanical calipers or thickness gauges when used for exterior measurement purposes. However, in addition to providing very precise exterior dimensional measurements with a translating member and inline base for exterior thickness measurements, the device will also measure wall thicknesses of a tube or conduit. The device as disclosed employs a novel and unique traverse translatable member which may be slid into the line of translation of a horizontal first member. A bulbous or ball shaped distal end portion of the traverse member, for the measurement of the wall thickness of the planar or curved sidewall of a tube and pipe through the aperture at the distal end of such tubes or pipes. This is accomplished by translating the traverse member to line up the bulbous portion with the first member which normally translates to its position against the base. With the bulbous portion inline, the first member may be zeroed against it and then the bulbous portion placed inside the tube or conduit and a second measurement of differential taken to ascertain wall thickness.

Conventional measuring gauges lack this structure and hence the herein disclosed additional utility of being able to measure both inside wall thickness of curved or planar sidewalls of tubes and conduits, along with exterior dimensions of a component for thickness of the component itself. Besides providing more accurate measurements the disclosed device also alleviates the need for two measurement gauges, one for the interior and one for exterior measurements.

It is thus an object of the invention to provide a device for measuring both the exterior diameter or thickness of a component or part placed therein, and also to allow measurement of both the planer or curved wall thicknesses of pipe and tubing through the aperture at the distal end of such a pipe or conduit.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWINGS

FIG. 1 depicts the device employed to measure exterior thickness of a component showing the horizontally translatable member in contact with the base.

FIG. 2 is a depiction of the device herein configured to measure tube or pipe wall thickness using a unique translatable base member translated to intersect the path of the horizontally translatable member.

### DETAILED DESCRIPTION OF THE PREFERRED EMBODIMENT

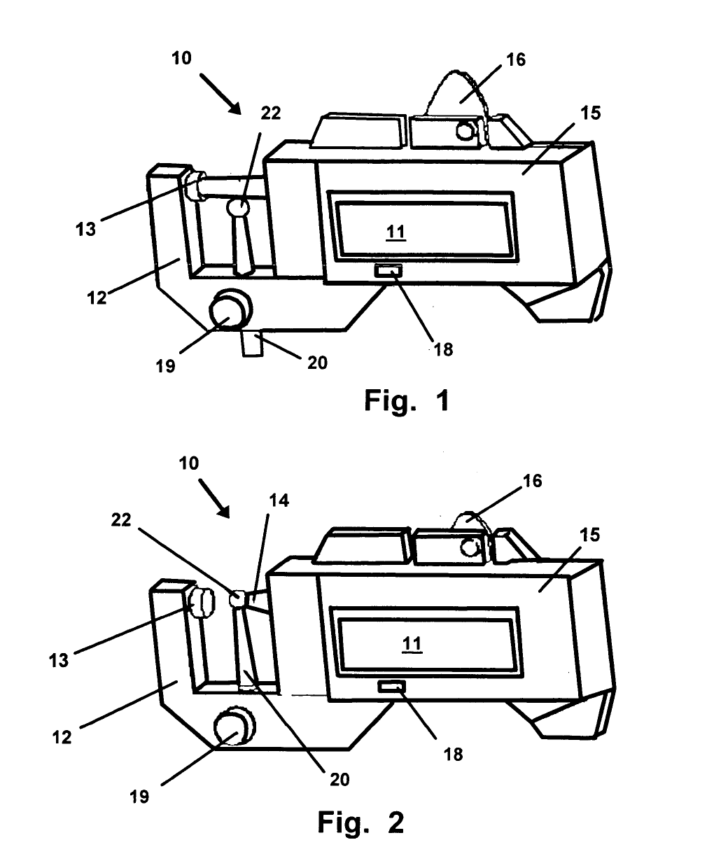

As shown in FIG. 1, the device 10 may be employed in a conventional fashion to measure the outside diameter or external thickness of a part or surface placed between the base 12 and a horizontal or first translating member 14. Using the dial 16 engaged to translating member 14, the member 14 is translated toward the base 12 to a contact point 13. At this point a zero button 18 may be depressed thereby positioning determined distance of travel of the translating member 14 of the device 10 at a zero position and ready to measure any part placed between the member 14 and the base 12. A part so placed and engaged in a slight contact between the base 12 and member 14 will yield a differential reading on the display 11 housed in the body 15 of the device 10 will thus show the thickness or diameter of the component so measured. Function of such digital displays 11 is well known to those skilled in the art and generally employ a means for electronic determination of the travel distance of the member 14 along its axis and an electronic means of communication of that travel distance to the digital display 11. Magnetic or optical or other means of determining the travel distance are well known in the art and included herein by reference as is the electronic communication of that determined distance after being zeroed, to the display 11, where it is readable as indica on the display.

Unlike other conventional calipers adapted for accurate exterior part or component measurements, the device 10 herein will also measure wall thickness of tubes or pipes which conventionally may not be measured with a translating member 14 due to the small size of the aperture at the end of most such conduits and pipes.

When measuring a conduit or tube wall thickness, a second member 20 having a second base 22 at its distal end may be translated into the path taken by the translating member 14 towards its engagement with the base 12. In a particularly preferred mode of the device 10 herein, a ball or globular dimensional shape works especially well for the second base 22 on the distal end of the second member 20 when used to measure a round tube and pipe wall thickness. This ball shape allows for easy measurements no matter what the angle of the device 10 to the pipe or conduit wall and works particularly well for curved interior surfaces of such pipes and conduits. A planar distal end defining the second base 22 on the second member 20 might also be employed but would not work as well as the globe shaped mode since the planar shape inhibits proper contact with a curved interior sidewall of a conduit or tube being measured.

In use for the secondary function of measuring tube, pipe, or conduit wall thickness, once the distal end having the second base 22 thereon is properly aligned within the path of the translating member 14 toward the base 12, the translating member 14 is adjusted to contact the distal end of the second member 20 which forms the second base 22 and the device is again zeroed using the zero button 18. Thereafter a tube or pipe may be slid over the second base 22 on the distal end of the second member 20 and the translating member 14 thereafter translated by the dial 16 having a frictional or other means of engagement of the translating member 14, to a point off contact with the exterior of the tube or pipe wall. This places the translating member 14 in contact with the exterior of the tube or conduit, and the globular distal end in contact with the interior wall of the pipe or conduit at a measurement point. The displayed measurement on the display 11 will be the differential between the contact with the second base 22 and the contact with the exterior surface of the tube or conduit thus yielding a wall thickness measurement of the tube, pipe, conduit, or any other hollow member formed of a sidewall surrounding an axial cavity.

A screw lock 19 is shown as employed as a means to maintain the second member 20 properly extended to a measuring position to thereby place the second base 22 at the distal end, in the path of the translating member 14 toward the first base 12. The screw lock 19 thus provides means for releasable fixed engagement of the second member 20 to positions either in or out of the path of the translating member 14.

While all of the fundamental characteristics and features of the digital thickness gauge for both exterior and wall thickness measurements of hollow components have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A measuring instrument with a digital display comprising:
a base having a first end and having a distal end;
a first member, said first member having a first end and a distal end;
means for translatable engagement of said first member with said base;
said first member translatable along a first axis to a first contact point between said distal end of said first member and said distal end of said base;
a second member translatably engaged with said first member and translatable along a second axis traverse to and intersecting said first axis;
a distal end of said second member positionable between a retracted position and an extended position;
said first member translatable along said first axis to a second contact point between said distal end of said second member in said extended position and said distal end of said first member;
means for electronic determination of a travel distance of said first member along said axis and communication of said travel distance to said digital display; and
means to zero said travel distance when said first member reaches said first or said second contact point, whereby a thickness of material in a contact with said first member and said base or with said first member and said distal end of said second member in said extended position, subsequent to said distance being zeroed, is displayed by indica on said digital display.

2. The measuring instrument of claim 1 additonally comprising:
said distal end of said second member having a curved surface defining a curved shape to said distal end;
said second contact point occurring at a contact between said curved surface of said distal end of said second member and said distal end of said first member.

3. The measuring instrument of claim 1 additonally comprising:
said distal end of said second member having a globular shape;
said second contact point occurring at a contact between a curved surface of said distal end of said second member and said distal end of said first member.

4. The measuring instrument of claim 1 additonally comprising:
releasable means to maintain said distal end of said second member positionable at one of said retracted position or said extended position.

5. The measuring instrument of claim 2 additonally comprising:
releasable means to maintain said distal end of said second member positionable at one of said retracted position or said extended position.

6. The measuring instrument of claim 3 additonally comprising:
releasable means to maintain said distal end of said second member positionable at one of said retracted position or said extended position.

7. The measuring instrument of claim 1 additonally comprising:
a housing, said housing providing an engagement of said digital display to said first end of said base.

8. The measuring instrument of claim 2 additonally comprising:
a housing, said housing providing an engagement of said digital display to said first end of said base.

9. The measuring instrument of claim 3 additonally comprising:
a housing, said housing providing an engagement of said digital display to said first end of said base.

10. The measuring instrument of claim 4 additonally comprising:
a housing, said housing providing an engagement of said digital display to said first end of said base.
